(19) United States
(12) Patent Application Publication
(10) Pub. No.: US 2025/0337185 A1
(43) Pub. Date: Oct. 30, 2025

(54) Terminal Position Holder, Connector Housing Assembly and Connector

(71) Applicants: Tyco Electronics (Suzhou) Ltd., Suzhou City (CN); Tyco Electronics (Shanghai) Co., Ltd., Shanghai (CN)

(72) Inventors: Feng (Charles) Wan, Shanghai (CN); Hua (Fofo) Zhong, Suzhou (CN); Zhihui (Vito) Tang, Suzhou (CN)

(73) Assignees: Tyco Electronics (Suzhou) Ltd., Suzhou City (CN); Tyco Electronics (Shanghai) Co., Ltd., Shanghai (CN)

(21) Appl. No.: 19/188,467

(22) Filed: Apr. 24, 2025

(30) Foreign Application Priority Data
Apr. 25, 2024 (CN) 202410511435.6

(51) Int. Cl. H01R 13/424

(52) U.S. Cl. CPC H01R 13/424

(57) ABSTRACT

A terminal position holder includes a plate-shaped body insertable into a slot of a connector housing and an elastic cantilever formed on the plate-shaped body. The elastic cantilever has a locking feature on an end that engages a terminal locking spring arm inside the connector housing to lock the plate-shaped body in the slot. The elastic cantilever has a root that rests against an end of the terminal locking spring arm and prevents the terminal locking spring arm from being moved from a locking position to an unlocking position.

### CROSS-REFERENCE TO RELATED APPLICATION

This application claims the benefit of the filing date under 35 U.S.C. § 119(a)-(d) of Chinese Patent Application No. 202410511435.6, filed on Apr. 25, 2024.

### FIELD OF THE INVENTION

The present invention relates to a terminal position holder for preventing accidental unlocking of terminals of a connector, a connector housing assembly comprising the terminal position holder, and a connector comprising the connector housing assembly.

### BACKGROUND

A connector typically includes a housing and terminals arranged in the sockets of the housing. In order to prevent the terminal from being pulled out of the housing, a locking spring is usually formed in the socket of the housing, which engages with the terminal to lock it in the socket of the housing. When pulling out the terminal, it is necessary to first push the locking spring to the unlocking position separated from the terminal. In order to prevent the terminal from being accidentally unlocked, it is necessary to insert a terminal position holder into the housing, which is used to prevent the locking spring from being pushed to the unlocking position, thereby preventing the terminal from being accidentally unlocked.

In order to lock the terminal position holder in a predetermined installation position, a locking protrusion needs to be formed on the terminal position holder, which is engaged with the snap slot on the peripheral wall of the housing to lock the terminal position holder in the predetermined installation position. The terminal position holder of this structure has a large volume and requires a lot of space, which can lead to the connector being too bulky.

### SUMMARY OF THE INVENTION

A terminal position holder includes a plate-shaped body insertable into a slot of a connector housing and an elastic cantilever formed on the plate-shaped body. The elastic cantilever has a locking feature on an end that engages a terminal locking spring arm inside the connector housing to lock the plate-shaped body in the slot. The elastic cantilever has a root that rests against an end of the terminal locking spring arm and prevents the terminal locking spring arm from being moved from a locking position to an unlocking position.

### BRIEF DESCRIPTION OF THE DRAWINGS

The invention will become apparent from the following description taken in conjunction with the accompanying drawings, and may help to provide a comprehensive understanding of the present disclosure, in which:

FIG. 1 shows an illustrative perspective view of a connector according to an exemplary embodiment of the present invention;

FIG. 2 shows a longitudinal sectional view of a connector housing assembly according to an exemplary embodiment of the present invention;

FIG. 3 shows an illustrative exploded view of a connector housing assembly according to an exemplary embodiment of the present invention when viewed from the rear side;

FIG. 4 shows an illustrative exploded view of a connector housing assembly according to an exemplary embodiment of the present invention when viewed from the front side;

FIG. 5 shows a horizontal sectional view of a connector housing according to an exemplary embodiment of the present invention;

FIG. 6 shows an illustrative perspective view of a terminal position holder according to an exemplary embodiment of the present invention;

FIG. 7 shows a longitudinal sectional view of a terminal position holder according to an exemplary embodiment of the present invention when viewed from the rear side; and

FIG. 8 shows a longitudinal sectional view of a terminal position holder according to an exemplary embodiment of the present invention when viewed from the front side.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

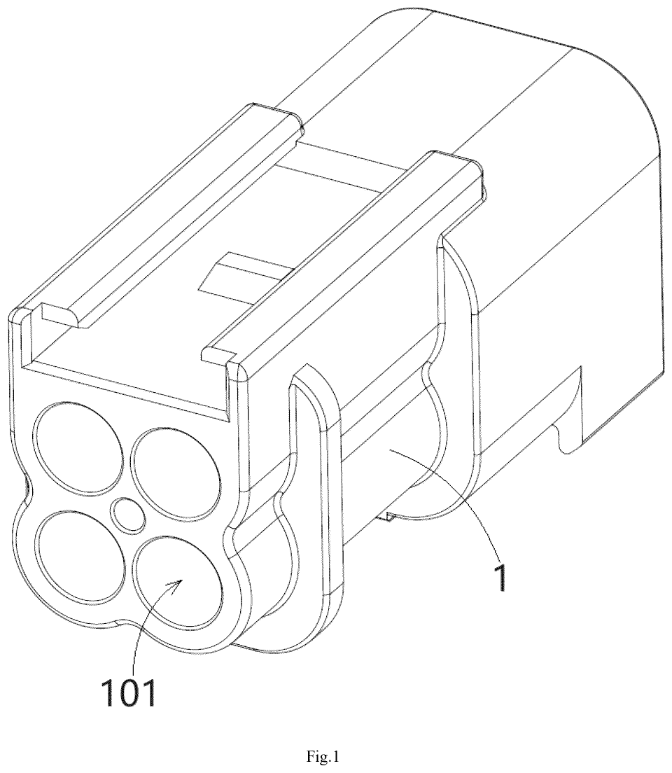

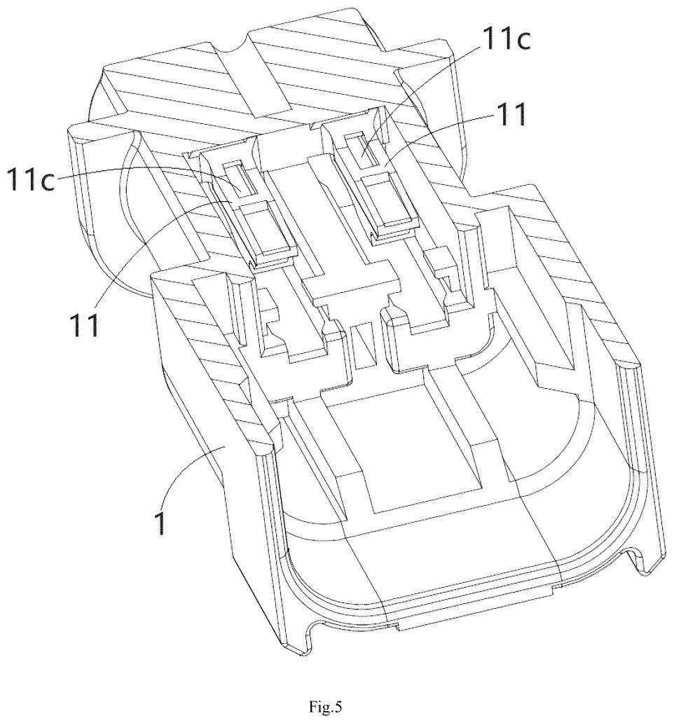

As shown in FIGS. 1 to 8, in an exemplary embodiment of the present invention, a terminal position holder 2 is disclosed. The terminal position holder 2 is used to prevent a terminal locking spring arm 11 inside a connector housing 1 from being moved from a locking position engaged with a terminal of a connector to an unlocking position separated from the terminal of the connector.

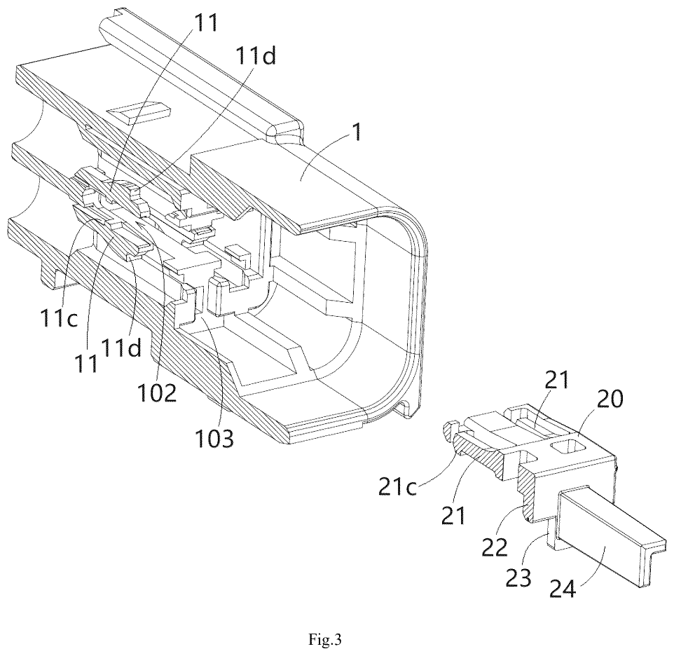

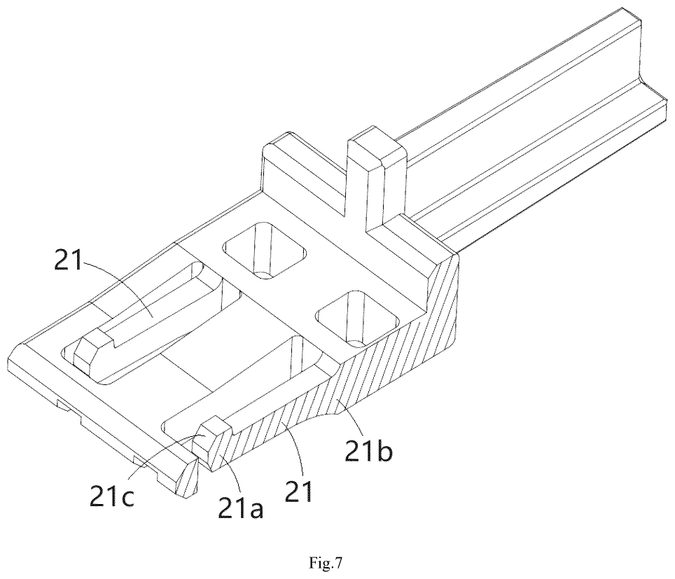

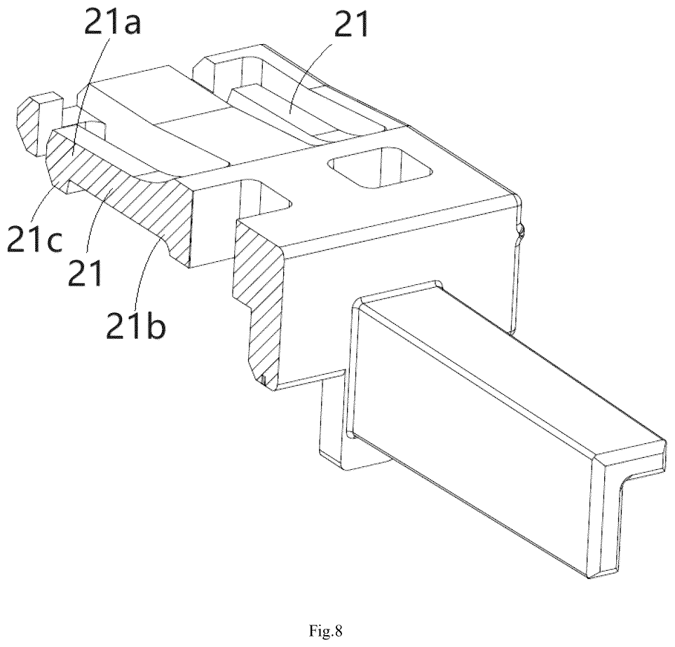

As shown in FIGS. 3, 4, and 6-8, in the illustrated embodiment, the terminal position holder 2 comprises a plate-shaped body 20 and an elastic cantilever 21. The plate-shaped body 20 is suitable for insertion into a slot 102 of the connector housing 1, shown in FIG. 3. The elastic cantilever 21 is formed on the plate-shaped body 20. A locking feature 21c suitable for engagement with the terminal locking spring arm 11 is formed on the end 21a of the elastic cantilever 21 to lock the plate-shaped body 20 in the slot 102. The root 21b of the elastic cantilever 21, shown in FIGS. 7 and 8, is adapted to rest against the end of the terminal locking spring arm 11 to prevent the terminal locking spring arm 11 from being moved to the unlocking position.

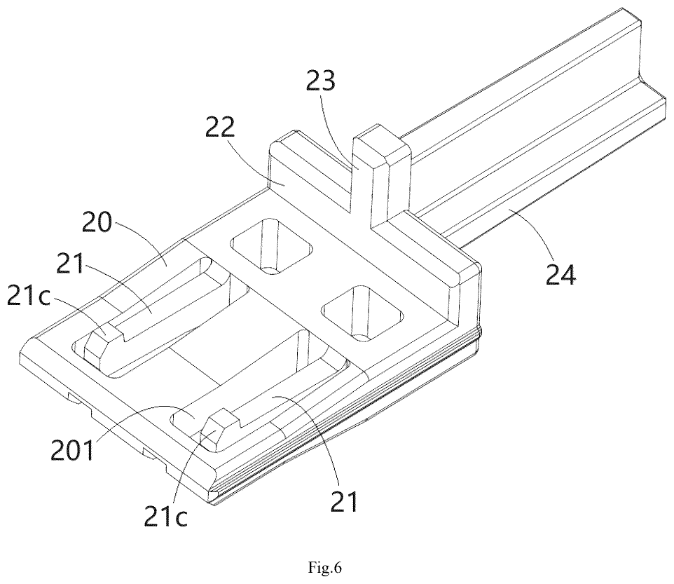

As shown in FIG. 6, in the illustrated embodiment, a window 201 is formed in the plate-shaped body 20, and the elastic cantilever 21 is suspended in the window 201 and extends a predetermined length along the longitudinal direction of the plate-shaped body 20. In the illustrated embodiment, multiple elastic cantilevers 21 arranged side by side along the transverse direction of the plate-shaped body 20 are formed on the plate-shaped body 20. Multiple windows 201 arranged side by side along the transverse direction of the plate-shaped body 20 are formed in the plate-shaped body 20, and multiple elastic cantilevers 21 are respectively suspended in the multiple windows 201.

As shown in FIG. 7, in the illustrated embodiment, the plate-shaped body 20 has a front end and a rear end that are opposite in its longitudinal direction, and the end 21a of the elastic cantilever 21 is close to the front end of the plate-shaped body 20.

As shown in FIG. 3, in the illustrated embodiment, the terminal position holder 2 further comprises an end plate 22 and a positioning key 23. The end plate 22 is connected to the rear end of the plate-shaped body 20. The positioning key 23 is formed on the end plate 22. The positioning key 23 is suitable for mating with a positioning slot 103 inside the connector housing 1 to position the terminal position holder 2 in a predetermined installation position.

As shown in FIGS. 3 and 6, in the illustrated embodiment, the terminal position holder further includes a handle portion 24, which is connected to the end plate 22 and extends backward from the end plate 22 to allow the plate-shaped body 20 to be inserted into or removed from the slot 102 by grasping the handle portion 24.

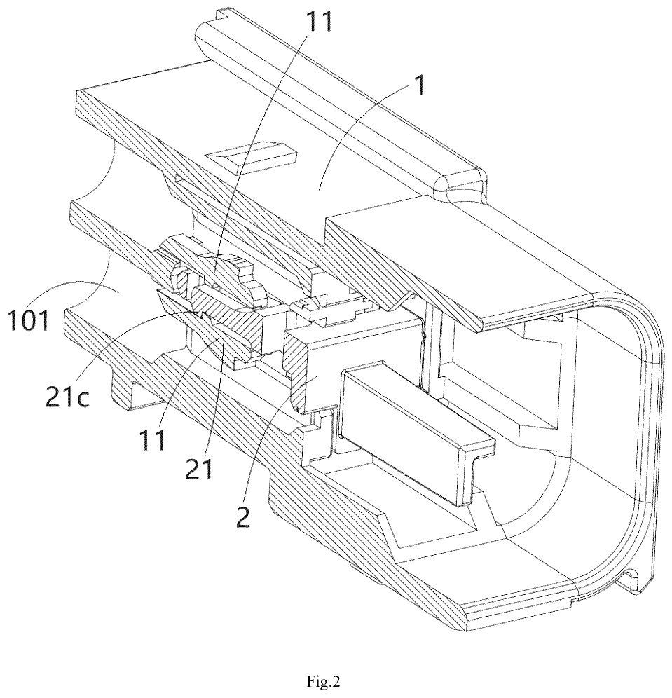

As shown in FIG. 2, in the illustrated embodiment, the end 21a of the elastic cantilever 21 of the terminal position holder 2 is adapted to rest against the terminal locking spring arm 11 to increase the elastic holding force of the terminal locking spring arm 11 on the terminal of the connector.

In another exemplary embodiment of the present invention, a connector housing assembly is also disclosed. The connector housing assembly includes a connector housing 1 and a terminal position holder 2. The connector housing 1 is formed with a socket 101, a terminal locking spring arm 11 and a slot 102, as shown in FIGS. 2 and 3. The socket 101 is used for inserting a terminal. The terminal locking spring arm 11 is formed in the socket 101 and is adapted to be moved between a locking position engaged with the terminal and an unlocking position separated from the terminal. The slot 102 is communicated with the socket 101. The plate-shaped body 20 of the terminal position holder 2 is inserted into the slot 102 of the connector housing 1.

In the illustrated embodiment, the root 21b of the elastic cantilever 21 of the terminal position holder 2 is adapted to rest against the end of the terminal locking spring arm 11 to prevent the terminal locking spring arm 11 from being moved from the locking position to the unlocking position, thereby preventing the terminal locking spring arm 11 from being accidentally unlocked. In the illustrated embodiment, the end 21a of the elastic cantilever 21 of the terminal position holder 2 is adapted to rest against the terminal locking spring arm 11 to increase the elastic holding force of the terminal locking spring arm 11 on the terminal. The end 21a of the elastic cantilever 21 of the terminal position holder 2 is located at the middle position between the end and root of the terminal locking spring arm 11.

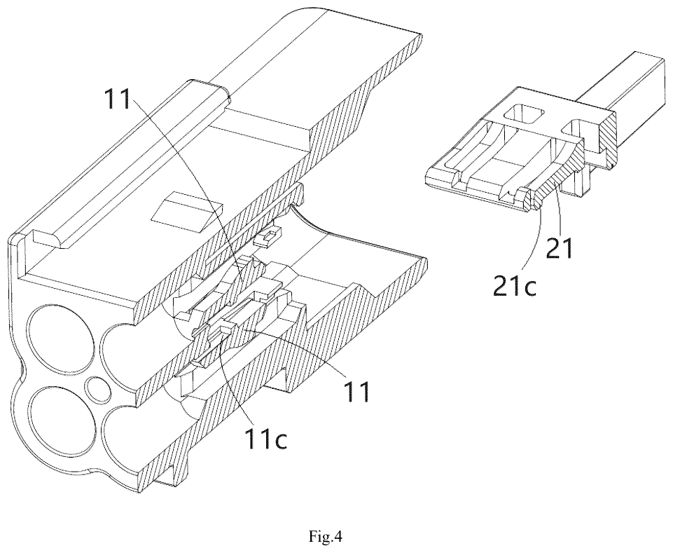

As shown in FIGS. 3 and 4, in the illustrated embodiment, a mating locking feature 11c is formed on the terminal locking spring arm 11, and the mating locking feature 11c is engaged with the locking feature 21c on the end 21a of the elastic cantilever arm 21 to lock the terminal position holder 2 in the predetermined installation position. In the illustrated embodiment, the locking feature 21c is a hook formed on the end 21a of the elastic cantilever arm 21, and the mating locking feature 11c is a snap slot formed on the terminal locking spring arm 11. However, the present invention is not limited to the illustrated embodiment. For example, in another exemplary embodiment of the present invention, the locking feature 21c may be a snap slot formed on the end 21a of the elastic cantilever 21, and the mating locking feature 11c may be a hook formed on the terminal locking spring arm 11.

As shown in FIG. 2, in the illustrated embodiment, the connector housing 1 has multiple sockets 101 and multiple terminal locking spring arms 11 respectively located in the multiple sockets 101. The multiple terminal locking spring arms 11 are arranged in opposite rows. The slot 102, shown in FIG. 3, is located between the two rows of terminal locking spring arms 11 and is communicated with the multiple sockets 101, so that the plate-shaped body 20 of the terminal position holder 2 inserted into the slot 102 is located between the two rows of terminal locking spring arms 11.

In the illustrated embodiment, a row of elastic cantilevers 21 is formed on the plate-shaped body 20 of the terminal position holder 2, and each elastic cantilever 21 in the row of elastic cantilevers 21 is inserted between the corresponding two terminal locking spring arms 11 in the two rows of terminal locking spring arms 11. The root 21b of each elastic cantilever 21 in the row of elastic cantilevers 21 is adapted to be clamped between the ends of corresponding two terminal locking spring arms 11 in two rows of terminal locking spring arms 11 to prevent the two rows of terminal locking spring arms 11 from being moved to the unlocking position.

As shown in FIG. 3, in the illustrated embodiment, a locking structure 11d is formed on the side of the terminal locking spring arm 11 facing away from the elastic cantilever 21. The locking structure 11d is adapted to engage with a mating locking structure on the terminal to lock the terminal in the socket 101.

In another exemplary embodiment of the present invention, a connector is also disclosed. The connector includes a connector housing assembly and a terminal. The terminal is inserted into the socket 101 of the connector housing 1. A mating locking structure is formed on the terminal, and the locking structure 11d on the terminal locking spring arm 11 is engaged with the mating locking structure on the terminal to lock the terminal in the socket 101. As shown in FIG. 3, in the illustrated embodiment, the locking structure 11d is a locking protrusion formed on the terminal locking spring arm 11, and the mating locking structure is a locking slot formed on the terminal.

In the aforementioned exemplary embodiments according to the present invention, the elastic cantilever of the terminal position holder is locked to the terminal locking spring arm of the housing, thereby reducing the volume of the terminal position holder and making the structure of the connector more compact and simpler.

In addition, in the aforementioned exemplary embodiments according to the present invention, the elastic cantilever of the terminal position holder can provide auxiliary support for the terminal locking spring arm of the housing, thereby increasing the elastic holding force of the terminal locking spring arm on the terminal.

In addition, in the aforementioned exemplary embodiments according to the present invention, the elastic cantilever of the terminal position holder is suspended in the window of the plate-shaped body; therefore, when shipped in bulk, the elastic cantilevers of the terminal position holders packaged together will not become entangled with each other, thereby reducing transportation damage.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A terminal position holder, comprising:
a plate-shaped body insertable into a slot of a connector housing; and
an elastic cantilever formed on the plate-shaped body, the elastic cantilever has a locking feature on an end that engages a terminal locking spring arm inside the connector housing to lock the plate-shaped body in the slot, the elastic cantilever has a root that rests against an end of the terminal locking spring arm and prevents the terminal locking spring arm from being moved from a locking position to an unlocking position.

2. The terminal position holder of claim 1, wherein a window is formed in the plate-shaped body, the elastic cantilever is suspended in the window and extends a predetermined length along a longitudinal direction of the plate-shaped body.

3. The terminal position holder of claim 2, wherein the elastic cantilever is one of a plurality of elastic cantilevers on the plate-shaped body that are arranged side by side along a transverse direction of the plate-shaped body, the window is one of a plurality of windows arranged side by side in the transverse direction and formed in the plate-shaped body, each of the elastic cantilevers is suspended in one of the windows.

4. The terminal position holder of claim 2, wherein the plate-shaped body has a front end and a rear end that are opposite in the longitudinal direction, the end of the elastic cantilever is adjacent to the front end of the plate-shaped body.

5. The terminal position holder of claim 4, further comprising an end plate connected to the rear end of the plate-shaped body and a positioning key formed on the end plate, the positioning key is matable with a positioning slot inside the connector housing to position the terminal position holder at a predetermined installation position.

6. The terminal position holder of claim 5, further comprising a handle portion connected to the end plate and extending backwards from the end plate, the plate-shaped body is insertable into or removable from the slot by gripping the handle portion.

7. The terminal position holder of claim 1, wherein the end of the elastic cantilever of the terminal position holder rests against the terminal locking spring arm to increase an elastic holding force of the terminal locking spring arm.

8. A connector housing assembly, comprising:
a connector housing having a socket receiving a terminal, a terminal locking spring arm formed in the socket and movable between a locking position engaged with the terminal and an unlocking position separated from the terminal, and a slot communicated with the socket; and
a terminal position holder including a plate-shaped body and an elastic cantilever formed on the plate-shaped body, the plate-shaped body is insertable into the slot of the connector housing, the elastic cantilever has a locking feature on an end that engages the terminal locking spring arm to lock the plate-shaped body in the slot, the elastic cantilever has a root that rests against an end of the terminal locking spring arm and prevents the terminal locking spring arm from being moved from the locking position to the unlocking position.

9. The connector housing assembly of claim 8, wherein the root of the elastic cantilever rests against the end of the terminal locking spring arm to prevent the terminal locking spring arm from being moved from the locking position to the unlocking position.

10. The connector housing assembly of claim 8, wherein the end of the elastic cantilever rests against the terminal locking spring arm to increase an elastic holding force of the terminal locking spring arm on the terminal, the end of the elastic cantilever is located at a middle position between the end of the terminal locking spring arm and a root of the terminal locking spring arm.

11. The connector housing assembly of claim 8, wherein a mating locking feature is formed on the terminal locking spring arm, the mating locking feature is engaged with the locking feature on the end of the elastic cantilever to lock the terminal position holder in a predetermined installation position.

12. The connector housing assembly of claim 11, wherein the locking feature is a hook formed on the end of the elastic cantilever, the mating locking feature is a snap slot formed on the terminal locking spring arm.

13. The connector housing assembly of claim 11, wherein the locking feature is a snap slot formed on the end of the elastic cantilever, the mating locking feature is a hook formed on the terminal locking spring arm.

14. The connector housing assembly of claim 8, wherein the socket is one of a plurality of sockets of the connector housing and the terminal locking spring arm is one of a plurality of terminal locking spring arms of the connector housing, each of the terminal locking spring arms is disposed in one of the sockets and the terminal locking spring arms are arranged in opposite rows.

15. The connector housing assembly of claim 14, wherein the slot is located between two rows of terminal locking spring arms and is communicated with multiple of the plurality of sockets, the plate-shaped body of the terminal position holder inserted into the slot is located between the two rows of terminal locking spring arms.

16. The connector housing assembly of claim 15, wherein the elastic cantilever is one of a plurality of elastic cantilevers arranged in a row on the plate-shaped body, each elastic cantilever in the row of elastic cantilevers is inserted between two terminal locking spring arms in the two rows of terminal locking spring arms.

17. The connector housing assembly of claim 16, wherein the root of each elastic cantilever in the row of elastic cantilevers is clamped between the ends of the two terminal locking spring arms in the two rows of terminal locking spring arms to prevent the two rows of terminal locking spring arms from being moved to the unlocking position.

18. The connector housing assembly of claim 8, wherein the terminal locking spring arm has a locking structure on a side of the terminal locking spring arm facing away from the elastic cantilever, the locking structure engages a mating locking structure on the terminal to lock the terminal in the socket.

19. A connector, comprising:
a connector housing assembly including:
a connector housing having a socket, a terminal locking spring arm formed in the socket and movable between a locking position and an unlocking position, and a slot communicated with the socket; and
a terminal position holder including a plate-shaped body and an elastic cantilever formed on the plate-shaped body, the plate-shaped body is insertable into the slot of the connector housing, the elastic cantilever has a locking feature on an end that engages the terminal locking spring arm to lock the plate-shaped body in the slot, the elastic cantilever has a root that rests against an end of the terminal locking spring arm and prevents the terminal locking spring arm from being moved from the locking position to the unlocking position; and
a terminal disposed in the socket, the terminal has a mating locking structure engaging a locking structure on the terminal locking spring arm to lock the terminal in the socket.

20. The connector of claim 19, wherein the locking structure is a locking protrusion formed on the terminal locking spring arm, the mating locking structure is a locking slot formed on the terminal.
